(19) United States
(12) Patent Application Publication
(10) Pub. No.: US 2026/0055795 A1
(43) Pub. Date: Feb. 26, 2026

(54) CLUTCH ASSEMBLY INCLUDING DUAL LAYER FRICTION MATERIAL AND METHOD FOR BONDING THE FRICTION MATERIAL LAYERS TO A CLUTCH PART

(71) Applicant: Schaeffler Technologies AG & Co. KG, Herzogenaurach (DE)

(72) Inventor: Michael YANETTA, Wadsworth, OH (US)

(21) Appl. No.: 18/812,560

(22) Filed: Aug. 22, 2024

(51) Int. Cl. F16D 69/02; F16D 69/00

(52) U.S. Cl. CPC F16D 69/026; F16D 2069/008; F16D 2200/0091

(57) ABSTRACT

A method of making a clutch assembly for a motor vehicle is provided. The method includes applying a colloid to at least one of a first wet friction material layer and a second wet friction material layer; arranging and aligning the second wet friction material layer on the first wet friction material layer with the colloid an interface between the first wet friction material layer and the second wet friction material layer, the colloid aiding in the arranging and aligning of the second wet friction material layer on the first wet friction material layer by causing adhesion of the second wet friction material layer to the first wet friction material layer; and then bonding the second wet friction material layer and the first wet friction material layer together by a binder.

The present disclosure relates generally to friction clutches and plates used in torque converters and other motor vehicle drivetrain components and more specifically to a clutch assembly including a wet friction material.

### BACKGROUND

WO2019173169A1, JP4166844B2, JP4074364B2 and KR100549565B1 disclose dual layer friction material.

### SUMMARY

A method of making a clutch assembly for a motor vehicle is provided. The method includes applying a colloid to at least one of a first wet friction material layer and a second wet friction material layer; arranging and aligning the second wet friction material layer on the first wet friction material layer with the colloid an interface between the first wet friction material layer and the second wet friction material layer, the colloid aiding in the arranging and aligning of the second wet friction material layer on the first wet friction material layer by causing adhesion of the second wet friction material layer to the first wet friction material layer; and then bonding the second wet friction material layer and the first wet friction material layer together by a binder.

In examples, the colloid is a mixture of a solid particles and a liquid.

In examples, the liquid is water.

In examples, the solid particles are a polysaccharide.

In examples, the polysaccharide is guar gum and/or carboxymethyl cellulose sodium.

In examples, a method further including attaching the first wet friction material layer to a rigid part.

In examples, the rigid part is a metal clutch plate.

In examples, the attaching of the first wet friction material layer to the rigid part includes attaching the first wet friction material layer to the rigid part by adhesive, prior to the applying of the colloid to the at least one of the first wet friction material layer and the second wet friction material layer.

In examples, the applying of the colloid to the at least one of the first wet friction material layer and the second wet friction material layer includes applying the colloid to the first wet friction material layer.

In examples, the bonding of the second wet friction material onto the first wet friction material including curing the binder at the interface to bond the second wet friction material layer onto the first wet friction material layer.

In examples, the curing of the binder is performed by heating the binder, the heating of the binder evaporating a liquid of the colloid.

In examples, the heating of the binder includes pressing a heated plate into the second wet friction material layer to cure the binder at the interface.

In examples, the heated plate includes a plurality of protrusions forming grooves into the second wet friction material layer when pressed onto the second wet friction material layer.

In examples, the binder includes a first binder and a second binder, the first binder being within a base material of one of the first wet friction material layer and the second wet friction material layer, the base material including a matrix of fibers and filler particles embedded in the matrix of fibers, the second binder being within a base material of the other of the first wet friction material layer and the second wet friction material layer, the base material including a matrix of fibers and filler particles embedded in the matrix of fibers.

In examples, a method wherein at least one of the first binder and the second binder is a tung-oil modified phenolic resin.

In examples, the first wet friction material and the second wet friction material are each a ring including an outer circumferential surface, an inner circumferential surface and two axially facing surfaces extending from the outer circumferential surface to the inner circumferential surface, the arranging and aligning of the second wet friction material on the first wet friction material including placing the second wet friction material onto the first wet friction material such that the colloid is sandwiched between one of the two axially facing surfaces of the first wet friction material and one of the two axially facing surfaces of the second wet friction material, and aligning the outer circumferential surface of the second wet friction material with the outer circumferential surface of the first wet friction material and aligning the inner circumferential surface of the second wet friction material with the inner circumferential surface of the first wet friction material.

In examples, the method further includes making the first wet friction material by: providing a base material including a matrix of fibers and filler particles embedded in the matrix of fibers; saturating the base material with a first binder; and partially curing the first binder; and making the second wet friction material by: providing a base material including a matrix of fibers and filler particles embedded in the matrix of fibers; saturating the base material with a second binder; and partially curing the second binder.

A clutch assembly for a motor vehicle drivetrain is also provided that includes a rigid support; and a wet friction material fixed to a surface of the rigid support, the wet friction material including: a first wet friction material layer; a second wet friction material layer; and polysaccharide particles sandwiched between the first wet friction material layer and the second wet friction material layer.

In examples, the first wet friction material layer and the second wet friction material layer are bonded together by a binder.

In examples, the binder includes a first binder and a second binder, the first binder being within a base material of one of the first wet friction material layer and the second wet friction material layer, the base material including a matrix of fibers and filler particles embedded in the matrix of fibers, the second binder being within a base material of the other of the first wet friction material layer and the second wet friction material layer, the base material including a matrix of fibers and filler particles embedded in the matrix of fibers.

### A BRIEF DESCRIPTION OF THE DRAWINGS

The present disclosure is described below by reference to the following drawings, in which:

FIG. 1a schematically shows a cross-sectional side view of portions of two wet friction material layers before a binder is added;

FIG. 1b schematically shows a cross-sectional side view of the portions of two wet friction material layers shown in FIG. 1a after a binder is added;

FIG. 1c schematically shows a perspective view of the two wet friction material layers;

FIG. 1d schematically shows a cross-sectional side view of the first wet friction material layer attached to a clutch plate;

FIG. 1e schematically shows a cross-sectional side view of the second wet frictional material layer being placed on the first wet friction material layer with a colloid at the interface between the two layers;

FIG. 1f schematically shows a cross-sectional side view of the first and second wet frictional material layers being bonded together; and

FIG. 2 shows the annular wet friction material 10 bonded to both sides of a metal part in the form of a clutch plate of lockup clutch assembly of a torque converter.

### DETAILED DESCRIPTION

The present disclosure provides a method of making a dual layer friction material that is different from the conventional process of combining two friction material layers during the paper making process, and allows a manufacturing facility that lacks paper making equipment for combining two friction material layers to form a dual layer friction material. A first friction material layer is attached to a metal part, a colloid is applied to the first friction material layer and/or a second friction material layer, and then the colloid aids in arranging and aligning the second friction material layer on the first friction material layer. After the second friction material layer is arranged and aligned on the first friction material, the second friction material layer is bonded to the first friction material layer. The bonding can be performed with a hot press that forms grooves in the second friction material layer.

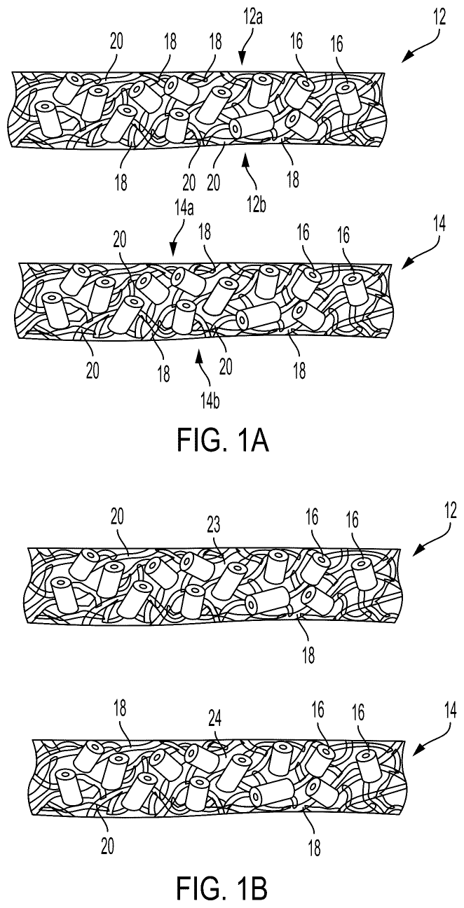

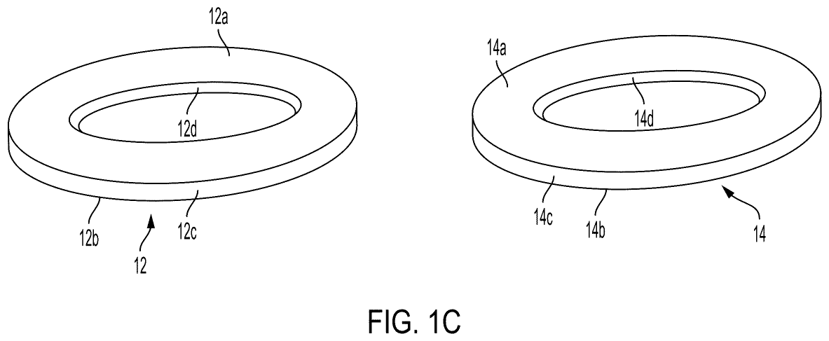

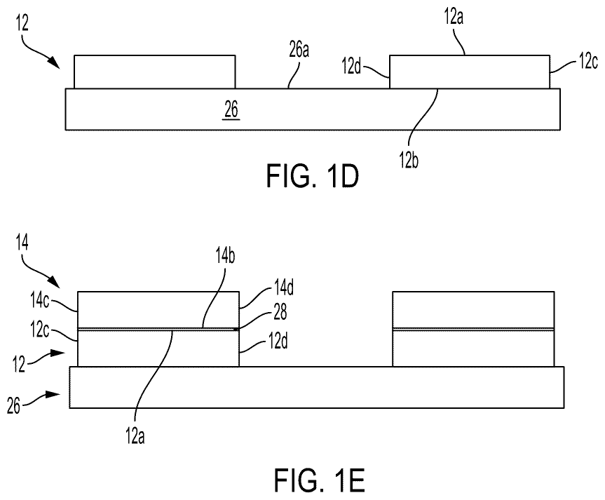

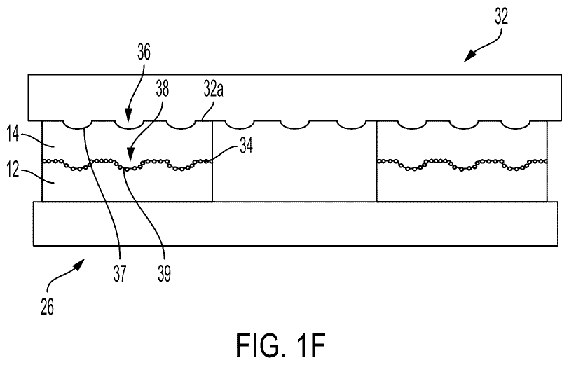

FIGS. 1a to 1f schematically illustrate a method of making an annular wet friction material 10 and a clutch assembly 11 in accordance with an embodiment of the present disclosure.

Two different wet friction material layers are prepared, including a first wet friction material layer 12 including a first composition and a second wet friction material layer 14 including a second composition.

Each wet friction material layer 12, 14 may be formed of fibers, filler material and a binder. The fibers may be aramid fibers, organic fibers, carbon fibers and/or fiberglass. The organic fibers may include cellulose fibers or cotton fibers. The filler particles may be diatomaceous earth. The binder may be a phenolic resin. Optionally a friction modifier such as graphite may also be included in layer 12 and/or layer 14.

FIG. 1a schematically shows layers 12 and 14 before the binder, in liquid form, is added. Layer 12 includes a material base formed by a plurality of filler particles 16 embedded in a matrix of aramid fibers 18 and cellulose fibers 20 between a first axially facing surface 12a and a second axially facing surface 12b of layer 12. Layer 14 also includes a material base formed by a plurality of diatomaceous earth particles 16 embedded in a matrix of aramid fibers 18 and cellulose fibers 20 between a first axially facing surface 14a and a second axially facing surface 14b of layer 14. Layer 12 can include a different percentage weight of cellulose fibers 20 than layer 14, and layer 14 can include a different percentage weight of aramid fibers 18 than layer 12.

Fibers 18, 20, particles 16 and any friction modifiers are joined together in a pulping process, which involves forming a mixture of the fibers 18, 20, particles 16 and any friction modifiers submerged together in a liquid solution, then drying the mixture to remove the liquid. After fibers 18, 20 and particles 16 are joined together by the liquid solution and dried, layers 12, 14 each include a matrix formed by fibers 18, 20 and filler particles 16 that define a network of voids 22.

As shown in FIG. 1b, after fibers 18, 20 and particles 16 are joined together, a respective binder 23, 24 is added to each of layers 12, 14 such that voids 22 (FIG. 1a) in layers 12, 14 between a matrix formed by 18, 20 and particles 16 are saturated with the binder 24. The layers 12, 14 can each be dipped in the binder, which can be phenolic resin, and squeezed through a stainless steel roller to remove excess binder. After excess binder is removed, the binder is subject to a first curing, which can be a B-stage or partial curing, where the layers 12, 14 are hardened but remain a level of flexibility. For example, this curing can be between 92% and 98%. In some preferred embodiments, at least one of the binders 23, 24 is a tung oil modified phenolic resin. Accordingly, one of binders 23, 24 can be a phenolic resin that is not tung oil modified, or both of the binders 23, 24 can be tung oil modified phenolic resin. The use of tung oil modified phenolic resin is advantageous for bonding strength between the two layers 12, 14.

In some preferred embodiments, prior to binder being added, one of layers 12, 14 can include, by weight percentage, 5 to 20% aramid fibers, 40 to 60% cellulose fibers and 20 to 45% filler particles, and the other of the layers 12, 14 can include, by weight percentage, 40 to 60% aramid fibers, 5 to 20% cellulose fibers and 20 to 45% filler particles. The filler particles of both layers 12, 14 can be diatomaceous earth. The binder is added on in weight percent that is 30-40% of the weight of the resulting friction material. Thus, after the first curing, one of layers 12, 14 can include, by weight percentage, 3 to 14% aramid fibers, 25 to 43% cellulose fibers, 13 to 32% filler particles and 30 to 40% binder, and the other of the layers 12, 14 can include, by weight percentage, 25 to 43% aramid fibers, 3 to 14% cellulose fibers and 13 to 32% filler particles.

As shown in FIG. 1c, the partially cured layers 12, 14 can be rings of friction material. Each of layers 12, 14 includes a respective outer circumferential surface 12c, 14c, a respective inner circumferential surface 12d, 14d, and the two respective axially facing surfaces 12a, 12b and 14a, 14b, extending from the respective outer circumferential surface 12c, 14c to the respective inner circumferential surface 12d, 14d.

As shown in FIG. 1d, the first frictional material layer 12 can then be attached to a rigid part in the form of a metal clutch plate 26. More specifically, adhesive can be applied to a planar surface 26a of clutch plate 26 and/or to second axially facing surface 12b of layers 12, and second axially facing surface 12b can be attached to planar surface 26a by the adhesive.

Next, as shown in FIG. 1e, a colloid 28 can be applied to at least one of a first wet friction material layer 12 and a second wet friction material 14. More specially, the colloid can be painted, rolled or sprayed onto first axially facing surface 12a and/or second axially facing surface 14b. In some embodiments, the colloid 28 can be applied to solely the first wet friction material layer 12.

The colloid 28 can be a mixture of a solid particles and a liquid. In some embodiments, the liquid can be water and the solid particles can be a polysaccharide. In more specific embodiments, the polysaccharide can be guar gum and/or carboxymethyl cellulose sodium. The colloid 28 can have a molar ratio of grams of powder to grams of water in the range of 1:100 through 1:200.

The colloid 28 is sufficiently viscous to provide a temporary adhesion between surfaces 12a, 14b when surfaces 12a, 14b are pressed together and the colloid is at an interface between surfaces 12a, 14b. The colloid 28 can advantageously have a viscosity of 400 to 1750 mPa·s, or more specifically 750 to 1500 mPa·s. As illustrated in FIG. 1e, the second frictional material layer 14 can be arranged and aligned on the first frictional material layer 12 with the colloid 28 an interface between the first wet friction material layer 14 and the second wet friction material layer 11. The colloid 28 aids in the arranging and aligning of the second wet friction material layer 14 on the first wet friction material layer 12 by causing adhesion of surface 14b of the second wet friction material layer 14 to surface 12a of the first wet friction material layer 12.

More specifically, as shown in FIG. 1e, the arranging and aligning of the second wet friction material 14 on the first wet friction material 12 can include placing the second wet friction material 14 onto the first wet friction material 12 such that the colloid 18 is sandwiched between surface 12a of the first wet friction material 12 and surface 14b of the second wet friction material 14, and aligning the outer circumferential surface 14c of the second wet friction material 14 with the outer circumferential surface 12c of the first wet friction material 12 and aligning the inner circumferential surface 14d of the second wet friction material 14 with the inner circumferential surface 12d of the first wet friction material 12.

Then, as shown in FIG. 1f, the second wet friction material layer 14 and the first wet friction material layer 12 are bonded together by curing the binders 23, 24 while the colloid 28 (FIG. 1e) is at the interface. As noted above, the binders 23, 24 were partially cured, as thus this curing can be considered a final or complete curing. Curing both of the binder 23 and binder 24 can provide a strong bond between the layers 12, 14. The binders 23, 24 can be cured by heating the binders 23, 24. More specifically, the heating can be performed by pressing a heat plate 32 against surface 14a of layer 14 to complete curing of the binder 23, 24 layers 12, 14, fixing layers 12, 14 together. The heating also causes the liquid of the colloid 28 to evaporate, leaving behind the solid particles 34. The force of pressing the heat plate 32 against surface 14a of layer 14, while surface 14b and surface 12a are pressed together, causes the binder 23, 24 to accumulate at the interface of surfaces 12a, 14b, while the curing of the binder 23, 24 by the heat of heat plate 31 creates a permanent connection between layers 12, 14. In one preferred embodiment, the heat at a surface 32a of plate 32 that contacts surface 14a of layer 14 is 375 to 450 degrees F. The heat plate 32 can include a plurality of protrusions 36 forming grooves 37 into surface 14a of the second wet friction material layer 14 when pressed onto the second wet friction material layer 14, which also forms protrusions 38 at surface 14b of the second wet friction material layer 14, and grooves 39 in surface 12a of first wet friction material layer 12.

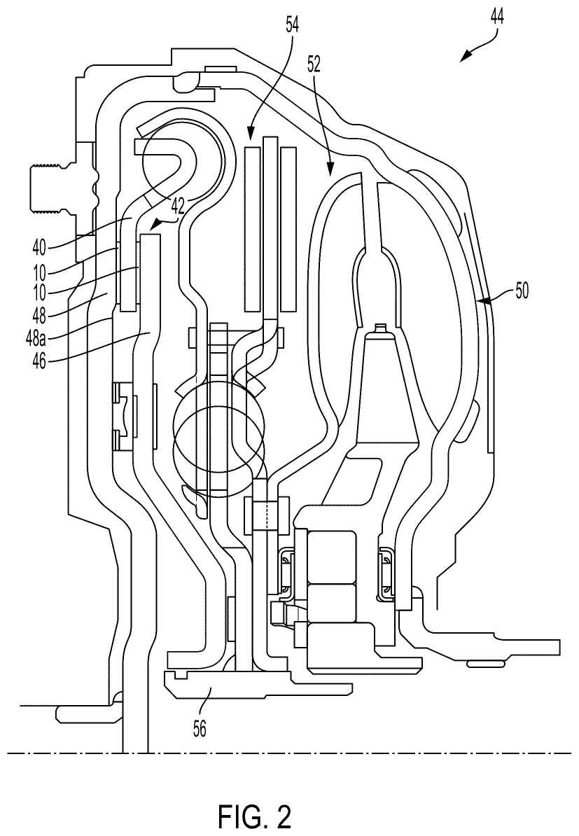

FIG. 2 shows annular wet friction material layer 10 bonded to both sides of a metal part in the form of a clutch plate 40 of lockup clutch assembly 42 of a torque converter 44. A piston 46 of lockup clutch assembly 42 forces clutch plate 40 against an inside surface 48a of a front cover 48 of torque converter 44. Piston 46 contacts the surfaces 26e, 28e of the rear wet friction material layer 10 to force the surfaces 26e, 28e on the front wet friction material layer 10 against inside surface 48a of front cover 48. The forcing of clutch plate 40 against front cover 48 by piston 46 locks the lockup clutch assembly 42 such that a torque path in torque converter 44 to a transmission input shaft bypasses an impeller 50 and a turbine 52 of torque converter 44, and instead flows from front cover 48 to clutch plate 40 and through a damper assembly 54 to a transmission input shaft that is connected to an output hub 56 of torque converter 44.

In the preceding specification, the disclosure has been described with reference to specific exemplary embodiments and examples thereof. It will, however, be evident that various modifications and changes may be made thereto without departing from the broader spirit and scope of disclosure as set forth in the claims that follow. The specification and drawings are accordingly to be regarded in an illustrative manner rather than a restrictive sense.

### LIST OF REFERENCE NUMERALS

10 annular wet friction material
11 clutch assembly
12 layers
12a surfaces
12b second axially facing surface
12c respective outer circumferential surface
12d respective inner circumferential surface
14 layers
14a surface
14b surfaces
14c respective outer circumferential surface
14d respective inner circumferential surface
16 particles
18 fibers
20 fibers
22 voids
23 binders
24 binders
26 metal clutch plate
26a planar surface
26e surfaces
28 colloid
28e surfaces
31 heat plate
32 heat plate
32a surface
34 solid particles
36 plurality of protrusions
37 grooves
38 protrusions
39 grooves
40 clutch plate
42 lockup clutch assembly
44 torque converter
46 piston
48 front cover
48a inside surface
50 impeller
52 turbine
54 damper assembly
56 output hub

What is claimed is:

1. A method of making a clutch assembly for a motor vehicle comprising:
applying a colloid to at least one of a first wet friction material layer and a second wet friction material layer;
arranging and aligning the second wet friction material layer on the first wet friction material layer with the colloid an interface between the first wet friction material layer and the second wet friction material layer, the colloid aiding in the arranging and aligning of the second wet friction material layer on the first wet friction material layer by causing adhesion of the second wet friction material layer to the first wet friction material layer; and then
bonding the second wet friction material layer and the first wet friction material layer together by a binder.

2. The method as recited in claim 1 wherein the colloid is a mixture of a solid particles and a liquid.

3. The method as recited in claim 2 wherein the liquid is water.

4. The method as recited in claim 2 wherein the solid particles are a polysaccharide.

5. The method as recited in claim 4 wherein the polysaccharide is guar gum and/or carboxymethyl cellulose sodium.

6. The method as recited in claim 1 further comprising attaching the first wet friction material layer to a rigid part.

7. The method as recited in claim 5 wherein the rigid part is a metal clutch plate.

8. The method as recited in claim 6 wherein the attaching of the first wet friction material layer to the rigid part includes attaching the first wet friction material layer to the rigid part by adhesive, prior to the applying of the colloid to the at least one of the first wet friction material layer and the second wet friction material layer.

9. The method as recited in claim 8 wherein the applying of the colloid to the at least one of the first wet friction material layer and the second wet friction material layer includes applying the colloid to the first wet friction material layer.

10. The method as recited in claim 1 wherein the bonding of the second wet friction material onto the first wet friction material including curing the binder at the interface to bond the second wet friction material layer onto the first wet friction material layer.

11. The method as recited in claim 1 wherein the curing of the binder is performed by heating the binder, the heating of the binder evaporating a liquid of the colloid.

12. The method as recited in claim 10 wherein the heating of the binder includes pressing a heated plate into the second wet friction material layer to cure the binder at the interface.

13. The method as recited in claim 12 wherein the heated plate includes a plurality of protrusions forming grooves into the second wet friction material layer when pressed onto the second wet friction material layer.

14. The method as recited in claim 1 wherein the binder includes a first binder and a second binder,
the first binder being within a base material of one of the first wet friction material layer and the second wet friction material layer, the base material including a matrix of fibers and filler particles embedded in the matrix of fibers,
the second binder being within a base material of the other of the first wet friction material layer and the second wet friction material layer, the base material including a matrix of fibers and filler particles embedded in the matrix of fibers.

15. The method as recited in claim 14 wherein at least one of the first binder and the second binder is a tung-oil modified phenolic resin.

16. The method as recited in claim 1 wherein the first wet friction material and the second wet friction material are each a ring including an outer circumferential surface, an inner circumferential surface and two axially facing surfaces extending from the outer circumferential surface to the inner circumferential surface,
the arranging and aligning of the second wet friction material on the first wet friction material including placing the second wet friction material onto the first wet friction material such that the colloid is sandwiched between one of the two axially facing surfaces of the first wet friction material and one of the two axially facing surfaces of the second wet friction material, and aligning the outer circumferential surface of the second wet friction material with the outer circumferential surface of the first wet friction material and aligning the inner circumferential surface of the second wet friction material with the inner circumferential surface of the first wet friction material.

17. The method as recited in claim 1 further comprising:
making the first wet friction material by:
providing a base material including a matrix of fibers and filler particles embedded in the matrix of fibers;
saturating the base material with a first binder; and
partially curing the first binder; and
making the second wet friction material by:
providing a base material including a matrix of fibers and filler particles embedded in the matrix of fibers;
saturating the base material with a second binder; and
partially curing the second binder.

18. A clutch assembly for a motor vehicle drivetrain comprising:
a rigid support; and
a wet friction material fixed to a surface of the rigid support, the wet friction material comprising:
a first wet friction material layer;
a second wet friction material layer; and
polysaccharide particles sandwiched between the first wet friction material layer and the second wet friction material layer.

19. The clutch assembly as recited in claim 18 wherein the first wet friction material layer and the second wet friction material layer are bonded together by a binder.

20. The clutch assembly as recited in claim 19 wherein the binder includes a first binder and a second binder,
the first binder being within a base material of one of the first wet friction material layer and the second wet friction material layer, the base material including a matrix of fibers and filler particles embedded in the matrix of fibers,
the second binder being within a base material of the other of the first wet friction material layer and the second wet friction material layer, the base material including a matrix of fibers and filler particles embedded in the matrix of fibers.
